(19) United States
(12) Patent Application Publication
(10) Pub. No.: US 2023/0329274 A1
(43) Pub. Date: Oct. 19, 2023

(54) CONFECTIONERY COMPOSITIONS

(71) Applicant: Cargill, Incorporated, Wayzata, MN (US)

(72) Inventors: Vanessa Barey, Marcq-en-Baroeul (FR); Gaelle Colette Marie-Hélène Gautier, Mons-en-Baroeul (FR)

(73) Assignee: Cargill, Incorporated, Wayzata, MN (US)

(21) Appl. No.: 18/044,592

(22) PCT Filed: Sep. 14, 2021
(86) PCT No.: PCT/US2021/050256

§ 371 Date: Mar. 9, 2023

(30) Foreign Application Priority Data
Sep. 15, 2020 (EP) 20196176.0

(51) Int. Cl. A23G 1/40; A23G 1/48

(52) U.S. Cl. CPC A23G 1/40; A23G 1/48

(57) ABSTRACT

The present invention relates to a reduced-sugar and/or vegan confectionery composition, such as a chocolate composition, comprising a bulking agent. The confectionery composition is free or substantially free of high intensity sweeteners and the bulking agent comprises a partially hydrolysed starch such as maltodextrin and/or a dietary fibre such as inulin.

### CROSS-REFERENCE TO RELATED APPLICATIONS

This application claims the benefit of European Patent Application No. 20196176.0, filed Sep. 15, 2020, which is incorporated by reference herein in its entirety.

### FIELD OF THE INVENTION

The invention relates to confectionery compositions comprising partially hydrolysed starch and/or dietary fibres.

### BACKGROUND

Most confectionery, such as chocolate, traditionally contains sugar (typically sucrose). Sugar serves several vital functions in chocolate. Most importantly, it provides bulk and plays a significant role in the structure, volume and mouthfeel of the finished product. It also provides sweetness. There is a growing pressure on the food industry to use less sugar in order to reduce sugar consumption and associated health issues in the global population. Several countries have enacted laws requiring the sugar content of commercial foods to be below a certain threshold. For example, the UK government has set a challenge to reduce overall levels of sugar by 20% in confectionery products by 2020.

However, formulating foods without sugar or with reduced sugar content is challenging because a sugar replacement will ideally not only replace the sweetness of sugar, but also fulfil all of sugar's other various functions, like being a bulking agent. Taking chocolate as an example, it is not possible to replace the sugar with the other typical ingredients in chocolate, such as cocoa butter, without increasing the overall energy (calorific) value.

Therefore, there is a need for a suitable bulking agent to fully or partially replace the sugar in confectionery compositions, which is both low in fat and low in sugar, whilst maintaining the sweetness and functional (e.g., structural) characteristics of sugar.

To date, solutions have involved the use of artificial or high intensity sweeteners such as aspartame, acesulfame-K, saccharin, sucralose or xylitol. Unfortunately, these sweeteners are often not well perceived by the consumer, can disrupt flavors (with bitter after-tastes or liquorish notes), and can have undesirable side-effects (such as laxative effects). There is therefore a need for a solution that provides sufficient bulking without requiring the use of such sweeteners.

The present invention aims to provide a sugar reduced confectionery composition with good texture and taste, but which avoids or ameliorates the aforementioned problems.

### SUMMARY OF THE INVENTION

The applicant unexpectedly found that certain dietary fibres can advantageously be used as a sugar and/or milk solids replacements in confectionery compositions. Surprisingly, it was found that these dietary fibres are effective as bulking agents, such as for sugar and/or milk solids reduction in confectionary compositions, without the need for any other additional ingredients such as high intensity or artificial sweeteners.

The applicant also unexpectedly found that a combination of partially hydrolysed starch and dietary fibre can advantageously be used as a sugar and/or milk solids replacement in confectionery compositions. The combination of partially hydrolysed starch and dietary fibres was found to be a particularly effective bulking agent, which may be used for sugar and/or milk solids reduction in confectionery compositions, such as chocolate compositions. Surprisingly, it was found that the combination of partially hydrolysed starch and dietary fibre provides benefits whilst reducing unwanted side-effects.

In one aspect, the invention provides a bulking agent comprising a partially hydrolysed starch for use in a confectionary composition.

In one aspect, the invention provides a bulking agent comprising a dietary fibre for use in a confectionary composition.

In one aspect, the invention provides a bulking agent comprising a partially hydrolysed starch and a dietary fibre for use in a confectionery composition.

Advantageously, the dietary fibre is inulin, oligofructose, resistant dextrin, bran, cocoa fibre, bamboo fibre or a mixture of two or more thereof. Preferably, the bran is wheat bran. More preferably, the wheat bran is micronized.

The dietary fibre may be cocoa fibre. Preferably, the cocoa fibre is micronized.

The dextrose equivalence (DE) of the partially hydrolysed starch may be from 10 to 40, more preferably from 15 to 30.

The partially hydrolysed starch may be maltodextrin.

The partially hydrolysed starch may be low DE glucose syrup.

The ratio of partially hydrolysed starch to dietary fibre in a bulking agent may be 80:20, 70:30, 60:40, 50:50, 40:60, 30:70 or 20:80. Preferably the ratio of partially hydrolysed starch to dietary fibre is 50:50.

In one aspect of the invention, the confectionery composition is a chocolate composition.

The invention also provides for the use of a bulking agent as defined above as a full or partial replacement for sugar and/or milk solids in a recipe for a confectionery composition.

The invention also provides a confectionery composition comprising the bulking agent of the invention.

The confectionery composition may comprise from 10 to 25 wt % of the bulking agent relative to the total weight of the composition.

The confectionery composition may comprise from 4 to 20 wt % of partially hydrolysed starch. Preferably, the confectionery composition may comprise from 5 to 19 wt %, 6 to 18 wt %, 7 to 17 wt %, 8 to 16 wt %, 9 to 15 wt %, 10 to 14 wt %, 11 to 13 wt % or 12 wt % to 14 wt % of partially hydrolysed starch relative to the total weight of the composition.

Alternatively or additionally, the confectionery composition may comprise from 4 to 20 wt % of dietary fibre relative to the total weight of the composition. Preferably, the confectionery composition may comprise from 5 to 19 wt %, 6 to 18 wt %, 7 to 17 wt %, 8 to 16 wt %, 9 to 15 wt %, 10 to 14 wt %, 11 to 13 wt % or 12 wt % to 14 wt % of dietary fibre relative to the total weight of the composition.

The confectionery composition as defined above may comprise 45 wt % or less total sugars.

The confectionery composition as defined above may be substantially free of milk solids.

Preferably, the confectionery composition is a chocolate composition.

The invention also provides for a food product comprising the confectionery composition as defined above.

### DESCRIPTION OF INVENTION

Unless otherwise specified, all terms should be accorded a technical meaning consistent with the usual meaning in the art as understood by the skilled person.

All ratios, amounts, and percentages in the present description are relative to the total weight of the composition, unless otherwise specified.

All parameter ranges include the end-points of the ranges and all values in between the end-points, unless otherwise specified.

When used in this specification and claims, the terms “comprises” and “comprising” and variations thereof mean that the specified features, steps or integers are included. The terms are not to be interpreted to exclude the presence of other features, steps or components. In contrast, the terms “consist” or “consisting of” as used herein should be interpreted to exclude the presence of other features, steps or components.

### Confectionery Product

Confectionery products within the scope of the present invention include chocolate compositions, crystalline and non-crystalline products. Non-crystalline products within the scope of the present invention include hard candies, chewy candy, brittle, caramel, toffee, liquorice, jellies, chewing gums, gums. Crystalline products within the contemplation of the confectionery composition of the present invention encompass fondants and creams, fudge, nougats, marshmallows, pralines, pressed candies, e.g; tablets, marzipan and pastes and panned candies (dragees). Combinations of these products are also within the scope of confectionery compositions. For example, chocolate-coated crystalline or non-crystalline products. Preferably, confectionery products according to the present invention will comprise or consist of a chocolate composition.

### Chocolate Composition

As used herein, the terms “chocolate” and “chocolate composition” refer to any composition comprising cocoa solids in any amount, notwithstanding that in some jurisdictions chocolate may be legally defined by the presence of a minimum amount of cocoa solids and/or compounds that comprise cocoa butter or cocoa butter substitutes. Advantageously, the term chocolate composition refers to a composition that meets a legal definition of chocolate in any jurisdiction (preferably the US and/or EU) and also includes any product (and/or component thereof) in which all or part of the cocoa butter is replaced by cocoa butter equivalents, replacers, or substitutes. For example, the term chocolate composition may refer to a composition comprising no less than 35 wt. % of dry cocoa solids, no less than 18 wt. % of cocoa butter and no less than 14 wt. % of dry non-fat cocoa solids.

The term chocolate composition may also refer to chocolate compositions comprising cocoa butter and edible solids other than cocoa solids and to “chocolate-like” compositions comprising a suspension of edible solids in a continuous fat phase other than cocoa butter (e.g., Caramac®). The term chocolate composition may refer to an entire food product and/or a component thereof. The chocolate may be a dark, milk, white, ruby, or crumb chocolate, or variants thereof known to the person skilled in the art. It may also be a vegan chocolate composition. A vegan chocolate is free of any animal-based ingredients, including any dairy-based ingredients such as milk solids. The chocolate composition may be suitable for various applications, including but not limited to extrusion, moulding, enrobing, coating, dipping (e.g., for dipping ice-cream), spraying, making chocolate bars, chunks, chips, crumbs, vermicelli and/or sprinkles.

Advantageously, the chocolate composition may comprise a coating chocolate or filling chocolate for a confectionery composition.

The chocolate composition of the present invention may be produced using any chocolate making technique that is known in the art. Traditional chocolate making processes typically involve blending chocolate liquor (obtained from grinding and liquefying cacao nibs) with other ingredients such as cocoa butter, sugar, milk or milk powder, emulsifiers, flavourings or other additives. The blended ingredients are then refined before being subjected to conching, and then tempering to form the final product. Chocolate processing influences the rheological and organoleptic properties of the finished chocolate. In particular, the particle size is reduced to a desirable range (typically around 20-40 μm) in the final chocolate composition for good mouthfeel and texture.

### Partially Hydrolysed Starch

Partially hydrolysed starches are the dried products or aqueous dispersions of saccharides obtained by hydrolysis of starch using suitable acid or enzymes.

To obtain the partially hydrolysed starches of the present invention a variety of starting starch materials can be used. In certain aspects, the starting starch materials may be, but not limited to, corn/maize starch, potato starch, tapioca starch, pulse starch (including but not limited to pea starch), and rice starch. Other suitable starting starch materials may be sweet potato starch, wheat starch, mung bean starch, oat and barley starch. Such starting starch materials may come from regular (non-modified) starch crops or from starch crops that have been modified through cross-breeding or genetic engineering.

One skilled in the art will appreciate that the commercial production of hydrolysed starches may include the steps of (1) liquefaction (gelatinization or solubilisation of starch); (2) saccharification (hydrolysis, specific DE attainment); (3) clarification (removal of insolubles); (4) optionally refining using a carbon column or ion exchange resin; (5) evaporation to increase solids concentration; and (6) liquid hydrolysed starch load-out or spray drying.

There are many ways to carry out the hydrolysis step. The partially hydrolysed starch compositions described herein may be achieved, for example, through enzymatic hydrolysis techniques utilizing alpha-amylases such as DSM's Maxamyl™ HT Ultra.

In one aspect, the invention provides a bulking agent comprising a partially hydrolysed starch for use in a confectionary composition.

The partially hydrolysed starches for use in the present invention may have a dextrose equivalent (DE) value ranging from 10 to 40, preferably 15-30. The dextrose equivalence (DE) of the partially hydrolysed starch may be from 11 to 39, 12 to 38, 13 to 27, 14 to 36, 15 to 35, 16 to 36, 17 to 34, 18 to 33, 19 to 32, 20 to 31, 21 to 30, 22 to 29, 23 to 28, 24 to 27 or 25 to 26. The term, “dextrose equivalent (DE)”, as used herein, refers to the degree of starch hydrolysis, specifically, the reducing value of a starch hydrolysate material compared to the reducing value of an equal weight of dextrose, expressed as percent, dry basis, as measured by the Lane and Eynon method described in Standard Analytical Method E-26, Corn Refiners Association, 6th Edition, 1977, E-26, pp. 1-3.

The partially hydrolysed starch may advantageously be selected from maltodextrin, a low DE glucose syrup and mixtures thereof. Maltodextrin comprises glucose sub-units linked together predominately by α-1,4 glyosidic linkages. Resistant maltodextrin (also known as digestion resistant maltodextrin) is created by putting maltodextrin through an additional process that changes the α-1,4 glyosidic linkages. It is indigestible because our bodies do not have the enzymes necessary to break down the new bonds. Maltodextrin as defined herein does not encompass resistant maltodextrin.

Maltodextrins may be produced by the hydrolysis of starch with either acids or enzymes. Exemplary patents are U.S. Pat. Nos. 3,849,194; 3,853,706; 4,284,722; 4,447,532 and 5,612,202. Various maltodextrins are commercially available from the applicant Cargill, Incorporated. Preferably, the maltodextrin has a DE from 10 to 20.

In one aspect, the invention provides a bulking agent comprising low DE glucose syrup and inulin. In particular, a bulking agent comprising low DE glucose syrup and inulin can be used in confectionery compositions, such as chocolate compositions.

A low DE glucose syrup is any glucose syrup with a DE value below 40. Syrups are produced from starch, which is liquefied in the presence of acid or enzymes or both to convert the starch to smaller carbohydrate chains. The term, “syrup”, as used herein, refers to dried syrups or starch hydrolysates. Preferably, the low DE glucose syrup has a DE under 40. More preferably, the low glucose syrup has a DE from 20 to 24.

### Dietary Fibres

As used herein, the term, “dietary fibre” refers to an indigestible carbohydrate-based material. It encompasses carbohydrate polymers which are not hydrolyzed by the endogenous enzymes in the human small intestine.

Dietary fibres are commonly used in the food industry. There are many positive physiological effects associated with dietary fibre consumption, including effects on stool parameters, colonic health, mineral absorption in the colon, vitamin synthesis in the colon, the metabolic syndrome and immune system. Dietary fibres have a strong impact on the colonic ecosystem and serve as primary substrates for intestinal microbiota metabolism. Thus, the use of dietary fibre as an ingredient in confectionery products may be desirable for consumers that wish to increase the amount of fibre in their diet for health reasons. The dietary fibre may be a soluble or insoluble fibre. Examples of suitable dietary fibres include, without limitation, inulin, bran or cocoa fibre, bamboo fibre, oligofructose, resistant dextrin, and mixtures of two or more thereof.

### Inulin

In one aspect of the invention, the dietary fibre is a fibre from the fructan group such as inulin or oligofructose. Preferably, the dietary fibre will comprise inulin. Inulin consists of a beta-2-1-linked chain of fructose molecules, this chain having at its end an alpha-D-glucose unit at the reducing end. Inulin typically has an average degree of polymerisation of about 10. It occurs in economically recoverable amounts in various plants such as, for example, chicory roots and dahlia tubers. In addition, inulin has been found for example in Jerusalem artichokes and artichokes. The average chain lengths of the various inulins and their physico-chemical properties differ from plant species to plant species. Preferably, the inulin is native inulin from chicory roots.

### Bran

In another aspect of the invention, the dietary fibre is bran, preferably micronized bran. Bran is defined as the milling fraction from the cereal kernel containing pericarp, testa, aleurone layer, germ and part of the starchy endosperm. Preferably, it will comprise 50 wt % fibre or more relative to its total weight. The bran can be derived from any cereal plant. Preferably, the cereal is selected from wheat, oat, barley, corn, rice, rye, or millet or combinations thereof. More preferably, the bran is (micronized) wheat bran.

Cereal bran, such as wheat bran, can be processed to provide micronized cereal bran, in a process known as “micronization”. Micronization reduces the particle size of the bran to within the micrometer or nanometer range and also has the advantage of improving the homogeneity of the final product. Micronization typically involves mechanical processes such as milling, grinding, cutting, or crushing. It may also involve a size selection step, such as sieving. Micronized bran (e.g. micronized wheat bran) is used herein to refer to bran having a particle size below 1 mm, preferably below 0.5 mm, preferably below 0.25 mm, preferably below 0.15 mm, more preferably below 0.10 mm. Preferably, the micronized bran has 90 wt % of the particles below 1 mm, more preferably 90 wt % of the particles below 0.5 mm, even more preferably 90 wt % of the particles below 0.25 mm, even more preferably 90 wt % of the particles below 0.15 mm, most preferably 90 wt % of the particles below 0.1 mm.

The micronized cereal bran, preferably micronized wheat bran, can be heat treated according to processes known in the art, for example according to EP 2 677 875. Heat treatment can be carried out before or after milling. Heat treatment reduces microbial contamination.

### Cocoa Fibre

In another aspect of the invention, the dietary fibre is cocoa fibre in the form of micronized cocoa shells comprising 50 wt % dietary fibre or more, based on the total weight of micronized cocoa shell. Preferably 70% of the micronized cocoa shells (also referred to herein as “micronized cocoa fibres”) have a particle size of less than 250 μm, more preferably of less than 150 μm, more preferably of less than 100 μm, more preferably of less than 50 μm, more preferably of less than 10 μm.

Cocoa fibre is a natural, dietary fibre, which has a strong cocoa flavour and colour. Cocoa fibre unexpectedly provides a reduced sugar and/or vegan confectionary composition with a pleasant taste and texture without the need for any additional ingredients. Consumers are attracted to confectionery composition comprising only natural ingredients. Cocoa fibre is a natural dietary fibre which can be used as a bulking agent in confectionary compositions, to replace sugar and/or milk solids. The resulting confectionary compositions will advantageously contain only cocoa-based ingredients and fewer or no additives or artificial ingredients.

Advantageously, cocoa fibre alone may be used to replace (fully or partially) the sugar and/or milk solids in a chocolate composition.

Cocoa fibres can be processed to provide micronized cocoa fibres, in a process known as “micronization”.

### Use of Partially Hydrolysed Starch and Dietary Fibre for Reducing Sugar Content

The applicant has determined that the combination of partially hydrolysed starch and dietary fibre may be used as a bulking agent in confectionery compositions, such as chocolate, for reducing sugar content. Thus, the present invention provides bulking agents comprising partially hydrolysed starch and dietary fibres and confectionery compositions comprising said bulking agents. Preferably, the present invention provides confectionery compositions comprising maltodextrin and inulin as bulking agents.

The combination of partially hydrolysed starch and dietary fibres (preferably maltodextrin and inulin) unexpectedly provides a reduced sugar confectionary composition with a very pleasant taste and texture, without undesirable side effects, and without the need for high intensity sweeteners. For example, in chocolate compositions, the combination of partially hydrolysed starch and dietary fibres provides a desirable mouthfeel to the chocolate without unduly impacting flavor.

The ratio of partially hydrolysed starch to dietary fibre in a bulking agent may be 80:20, 70:30, 60:40, 50:50, 40:60, 30:70 or 20:80. Preferably, the ratio of partially hydrolysed starch to dietary fibre is 50:50.

The bulking agent of the present invention may be used as a full or partial replacement for sugar in a recipe for a confectionery composition. In one aspect, the bulking agent of the present invention may be used to replace 5%, 10%, 20%, 30%, 40%, 50% or all of the sugar in a confectionery composition.

The invention also provides a confectionery composition comprising the bulking agent of the invention, and advantageously comprising maltodextrin and inulin as the bulking agent. Preferably, the confectionery composition is a chocolate composition. Advantageously, the confectionery composition will be free or substantially free of high intensity sweeteners.

As used herein, the term “high intensity sweetener” refers to acesulfame K, Gem Sweet, L-sugars, Hernandulcin, neohesperidine dihydrochalone, aspartame, aspartyl-D-valine isopropyl ester, aspartyl amino malonates, dialkyl aspartyl aspartates, neotame, saccharin, trichloro sucrose, sucralose, alitame, thaumatine, cyclamate, glycyrrhizin, p-phenetylurea, 5-nitro-2 propoxyaniline, stevioside and/or related extracts from the leaves of the Stevia rebaudiana plant, mogrosides, Lo Han, xylitol, tagatose, trehalose and mixtures of two or more thereof. Describing a composition as being “substantially free” of high intensity sweetener means that high intensity sweeteners are not present in an amount sufficient to noticeably increase sweetness of the composition.

The reduced sugar confectionery composition may comprise from 10 to 25 wt % of the bulking agent relative to the total weight of the composition. Preferably, the confectionery composition may comprise 11 to 24 wt %, 12 to 23 wt %, 13 to 22 wt %, 14 to 21 wt %, 15 to 20 wt %, 16 to 19 wt % or 17 to 18 wt % of the bulking agent relative to the total weight of the composition.

The confectionery composition may comprise from 4 to 20 wt % of partially hydrolysed starch such as maltodextrin. Preferably, the confectionery composition may comprise from 5 to 19 wt %, 6 to 18 wt %, 7 to 17 wt %, 8 to 16 wt %, 9 to 15 wt %, 10 to 14 wt %, 11 to 13 wt % or 12 wt % to 14 wt % of partially hydrolysed starch relative to the total weight of the composition.

Alternatively or additionally, the confectionery composition may comprise from 4 to 20 wt % of dietary fibre such as inulin relative to the total weight of the composition. Preferably, the confectionery composition may comprise from 5 to 19 wt %, 6 to 18 wt %, 7 to 17 wt %, 8 to 16 wt %, 9 to 15 wt %, 10 to 14 wt %, 11 to 13 wt % or 12 wt % to 14 wt % of dietary fibre relative to the total weight of the composition.

The confectionery composition as defined above may comprise 45 wt % or less total sugars.

To comply with legal standards for reduced-sugar chocolates, the content of total sugars in a chocolate composition of the invention is preferably at least 30% less than that of equivalent commercial chocolates.

In one aspect, the total sugar content of a milk variety of a reduced-sugar chocolate composition in accordance with the invention is around 45 wt % or less, or preferably around 40 wt % or less, or more preferably around 36 wt % or less. Preferably, the total sugar content of a milk variety of a reduced-sugar chocolate composition in accordance with the invention is 0 to 45% wt, 10 to 40% wt, 20 to 35 wt % or 25 to 30 wt %.

In another aspect, the total sugar content of a dark chocolate variety of a reduced-sugar chocolate composition in accordance with the invention is around 40 wt % or less, or preferably around 30 wt % or less, or preferably around 27 wt % or less. Preferably, the total sugar content of a dark chocolate variety of a reduced-sugar chocolate composition in accordance with the invention is 0 to 40% wt, 10 to 35% wt, 20 to 30 wt % or 25 to 30 wt %.

The terms “total sugars” and “total sugar content” as used herein refer to the sum of all the sugars in the confectionery composition that contribute to the calorie content of the confectionery composition. This may include sugars (mono and disaccharides) that are intentionally added as an ingredient of the chocolate, as well as sugars that are intrinsic to, or naturally present in, other chocolate ingredients. Total sugars do not include polyols or high intensity sweeteners which may sometimes be used in reduced sugar confectionery recipes. Indeed, the composition of the present invention is preferably free or substantially free of such high intensity sweeteners.

Sugars that make up the total sugar content of the confectionery composition, may be selected from the group consisting of: monosaccharides, such as glucose, dextrose, fructose, allulose or galactose; disaccharides such as sucrose, lactose or maltose; as well as honey, agave syrup, maple syrup, and combinations of two or more thereof

The term “reduced sugar” can comprise confectionary compositions with a reduced sugar content compared to an equivalent composition that is known in the art, and/or to confectionary compositions including no added sugar.

The term “sucrose” as used herein includes sucrose in various forms including but not limited to standard (e.g., granulated or crystalline) table sugar, powdered sugar, caster sugar, icing sugar, sugar syrup, silk sugar, unrefined sugar, raw sugar cane, and molasses.

Advantageously, by using the bulking agent of the present invention, the sugar content of chocolate can be reduced without increasing the calorie content or energy value of the chocolate and without the use of high intensity sweeteners. Thus, the fat (e.g., cocoa butter) content of reduced-sugar chocolate compositions according to the invention is preferably substantially the same or similar to the fat content of equivalent commercial chocolates, such that the energy value of the chocolate is not increased. The total fat content of the reduced-sugar chocolate composition is determined by the intended application. For example, the total fat content may be around 40 wt % or less for milk chocolate bars, but may be higher for other applications, such as ice cream coatings. Preferably, the total fat content may be 0 to 40 wt %, 10 to 30 wt %, 15 to 25 wt % or 20 to 25 wt %. A person skilled in the field of the invention would be familiar with the fat content required for various applications.

### Use of Partially Hydrolysed Starch and Dietary Fibre to Replace Milk Solids

The applicant has determined that the combination of partially hydrolysed starch and dietary fibre, such as maltodextrin and inulin, may be used as a bulking agent in confectionery compositions, such as chocolate, to replace milk solids. Thus, the present invention provides bulking agents comprising partially hydrolysed starch and dietary fibres, preferably maltodextrin and inulin, and dairy-free or vegan confectionery compositions comprising said bulking agents.

The combination of partially hydrolysed starch and dietary fibres such as maltodextrin and inulin, unexpectedly provides a vegan confectionary composition with a very pleasant taste and texture, without undesirable side effects. For example, in vegan chocolate compositions, milk solids can be replaced with the combination of partially hydrolysed starch and dietary fibres while maintaining a desirable creamy taste and mouthfeel. Milk solids include milk fat, such as amorphous milk fat, milk and milk powders, such as defatted or skimmed milk powders, and any other dairy-based ingredients.

As above, the ratio of partially hydrolysed starch to dietary fibre in a bulking agent to replace milk solids may be 80:20, 70:30, 60:40, 50:50, 40:60, 30:70 or 20:80. Preferably, the ratio of partially hydrolysed starch to dietary fibre is 50:50.

The bulking agent of the present invention may be used as a full or partial replacement for milk solids in a recipe for a confectionery composition. In one aspect, the bulking agent of the present invention may be used to replace 5%, 10%, 20%, 30%, 40%, 50% or all of the milk solids in a confectionery composition. Preferably, the bulking agent will be used to replace all of the milk solids.

The invention also provides a confectionery composition comprising the bulking agent of the invention. Preferably, the confectionery composition is a vegan confectionery or chocolate composition. Preferably, it will be free or substantially free of high intensity sweeteners.

The vegan confectionery composition may comprise from 10 to 30 wt % of the bulking agent relative to the total weight of the composition. Preferably, the confectionery composition may comprise 11 to 29 wt %, 12 to 28 wt %, 13 to 27 wt %, 14 to 26 wt %, 15 to 25 wt %, 16 to 24 wt %, 17 to 23 wt %, 18 to 22 wt %, or 19 to 21 wt % of the bulking agent relative to the total weight of the composition.

Chocolate compositions according to the present invention may also comprise additional bulking agents that do not contain dietary fibre or partially hydrolysed starch. For example, one or more additional bulking agents may be added to further improve the texture and/or organoleptic properties of the chocolate and/or to facilitate the refining step of the manufacturing process.

Any suitable bulking agent known in the art may be used in combination with the bulking agent of the present invention, including soluble and/or insoluble fibres. Non-limiting examples of “insoluble fibre” that may be used in accordance with the present invention are, cereal fibres and/or other plant fibres. Non-limiting examples of “soluble fibre” that may be used in accordance with the present invention are resistant/modified maltodextrin, polydextrose, β-glucan, galactomannan, fructo-oligosaccharides, gluco-oligosaccharide, galacto-oligosaccharides, MOS (mannose-oligosaccharides, also known in the art as mannan-oligosaccharides or manno-oligosaccharides), psyllium, and mixtures of two or more thereof.

The chocolate composition according to the present invention may also include one or more additional ingredients such as emulsifiers (e.g., lecithin or PGPR), flavouring agents (e.g., vanilla extract or vanillin), flavour enhancers (e.g., salt), and the like. Preferably, however, it will be free or substantially free of high intensity sweeteners.

### EXAMPLES

### Measurement Methods

1. Particle size

Particle size for molten chocolate was measured using a micrometer. A small amount of chocolate was placed on the measuring surface of a Mitutoyo micrometer (0-25 mm). By pressing, an indication of the size of the largest non-compressible particles can be measured. The value is given in μm, and is known to represent approximately the D84 particle size.

2. Fat content

A refractometer RE40—METTLER TOLEDO was used to determine the refractive index at 20° C. of the filtrate resulting from the extraction of about 2 g of chocolate with 4.5 g of Bromo-1-naphtalene Merck 806210. The fat was extracted from the chocolate sample for about 20 minutes at 50° C. Depending on the refractive index obtained, the total fat content was then calculated (see Leithe, W., u. J. H. Heinz: Refraktometrische Fettbestimmung in Kakaowaren. Z. Unter-such. Lebensmittel 71, 414-418 (1936)).

### 3. Colour

Colour values are expressed as Hunter L, -a and -b values, where the L value represents the “brightness” of the product (black/white scale), the “a” value represents the amount of green/red and the “b” value represents the amount of yellow/blue. The quotient of “a” over “b” represents the redness of the product. The following procedure was used to determine the colour value of chocolate. A small amount of chocolate at 50° C. was poured into an optically neutral petri dish (diameter 55 mm) right to the top. The petri dish was then placed on a calibrated spectrocolorimeter Minolta CM2500D (Illuminant D65, 10° observer, read values in Hunter L-a and b values, software Minolta SPECTRA MAGIC version 1.00). The L, a and b-values of the chocolate sample were then measured by the device and recorded.

4. Flow properties

The flow behaviour of the chocolate was measured by ICA Analytical method 46 (2000) “Viscosity of Cocoa and Chocolate Products”, available from CAOBISCO Brussels, using a rheometer RM200 (Lamy Rheology Instruments, Champagne au Mont d'Or, France). This is a shear-rate imposed rheometer whereby its speed ranges from 0.3 to 1500 rpm and the torque from 0.05 to 30 mNm. The temperature of the measuring cell is kept at 40° C. A small amount of chocolate is brought into the tube. After pre-shearing the chocolate for 10 min at 5 s−1, a stepped flow procedure is applied by increasing and decreasing the shear rate while measuring the shear stress. The Casson model is used to define Casson Yield stress and Casson Viscosity for recipes with a fat content below 38%. For recipes with a fat content higher than 38% a polynomial model is used.

5. Sensory evaluation

All chocolate samples were tasted by experienced chocolate engineers, customers, and a trained panel of experts.

### Example 1

Three batches of milk chocolates were prepared containing varying amounts of inulin and maltodextrin using the ratios shown in Table 1. The maltodextrin is spray-dried maltodextrin obtained from Cargill (MD 01915). The inulin is chicory inulin, a soluble dietary fibre extracted from chicory roots and obtained from Cosucra (Fibruline Instant).

The chocolates were manufactured using the following conventional method.
Mixing: all the dry ingredients, the cocoa liquor and a part of the cocoa butter were mixed together for 10 minutes in a Hobart mixer at a temperature of 45 to 50° C. The cocoa butter addition was adapted on a case-by-case basis to get a correct texture for refining. Optimal fat content in the mixer was 23-27%.
Refining: the chocolate paste was then refined in a Bühler three roll refiner, in order to produce refiner flakes having a reduced particle size between 20 and 24 μm.
Conching: the refiner flakes were then dry-conched for 6 hours at a temperature of 65° C. in a 5 kg batch Bühler Elkolino monoshaft conche running clockwise at a rotor speed of 1000 rpm. Additional cocoa butter was added when needed during the filling of the conche, in order to ensure a proper mechanical shearing and a good flavour development thanks to the optimal texture in conche. At the end of the dry conching, remaining cocoa butter was added to the conche. The mixture was then wet-conched for 30 min at 1500 rpm counter-clockwise at a temperature of 45° C. The chocolate mass was then unloaded.
The viscosity and yield stress value of the chocolate were adjusted to the required specifications by adding cocoa butter and/or emulsifiers.
After adjustment of the rheology, the chocolate underwent a hand tempering process and was moulded into bars. Tempering involves the controlled heating and cooling of the mixture to selectively cause the crystallisation of the cocoa butter in the preferred crystalline form V.

TABLE 1
Milk chocolate compositions comprising maltodextrin and/or inulin

| | Recipe 1 | Recipe 2 | |
|---|---|---|---|
| | (comparative | (comparative | |
| | example) | example) | Recipe 3 |
| Sugar | 27.6 | 27.6 | 26.8 |
| Cocoa mass | 11.32 | 11.32 | 11.32 |
| Cocoa butter | 19.99 | 19.99 | 19.99 |
| Whole milk powder (26% fat) | 23.98 | 23.98 | 23.98 |
| Inulin | | 16.5 | 8.65 |
| Maltodextrin | 16.5 | | 8.65 |
| Soya lecithin | 0.6 | 0.37 | 0.6 |
| Vanilla flavouring | 0.01 | 0.01 | 0.01 |
| TOTAL | 100 | 100 | 100 |

Quantitative testing results are shown in Table 2. The viscosity, yield stress, and colour of all of the prepared chocolates were within an acceptable range for milk chocolate bars. The total sugar content was lower than equivalent commercial chocolates at between 36-38 wt %, whilst the fat content was similar to equivalent commercial chocolates at between 31 and 39 wt %.

The milk chocolate composition of recipe 3 comprised a ratio of 50:50 maltodextrin and inulin had a reduced particle size of 19 μm compared to chocolate compositions of recipes 1 and 2 comprising only inulin or only maltodextrin. The reduced particle size may account for the improved texture of this chocolate composition. The chocolates underwent sensory evaluation as outlined above. For the chocolate composition comprising both maltodextrin and inulin, the panel reported good texture, mouthfeel, taste and sweetness, with words like “creamy”, and “smooth” being used to describe the texture. The panel used words like “sticky” and “sandy” to describe the texture of the chocolate compositions comprising only inulin or only maltodextrin.

A reduced particle size also means that the chocolate composition is easier to grind and mould.

TABLE 2
Quantitative measurements of chocolate compositions
comprising maltodextrin and/or inulin

| | Recipe 1 | Recipe 2 | Recipe 3 |
|---|---|---|---|
| Fat (%) | 32.82 | 38.82 | 32.82 |
| Total Sugar (%) | 37.18 | 37.35 | 36.52 |
| Viscosity (Pa · s) | 1.38 | 2.23 | 1.92 |
| Yield value (Pa) | 10.1 | 7.43 | 9.90 |
| Particle size (μm) | 23 | 21 | 19 |
| L* | 45.4 | 45.49 | 48.05 |
| a* | 10.41 | 9.8 | 9.78 |
| b* | 16.37 | 14.11 | 15.1 |

### Example 2

Two batches of dark chocolates were prepared containing varying amounts of inulin and maltodextrin using the ratios shown in Table 3. The dark chocolate compositions according to the invention were made by following the same methodology as in example 1, with the only difference being that that the refiner flakes were dry-conched for 6 hours at a temperate of 80° C.

TABLE 3
Dark chocolate compositions comprising maltodextrin and inulin

| | Recipe 4 | Recipe 5 |
|---|---|---|
| Sugar | 27.6 | 30.09 |
| Cocoa mass | 46.4 | 47.54 |
| Cocoa butter | 8.6 | 1.5 |
| Inulin | 8.25 | 10.1 |
| Maltodextrin | 8.25 | 10.1 |
| Soya lecithin | 0.57 | 0.66 |
| Vanilla flavouring | 0.01 | 0.01 |
| TOTAL | 100 | 100 |

Quantitative testing results are shown in Table 4. The viscosity, yield stress, and colour of all of the prepared chocolates were within an acceptable range for dark chocolate bars. The total sugar content was lower than equivalent commercial chocolates at between 29-32 wt %, whilst the fat content was similar to equivalent commercial chocolates at between 27 and 34 wt %.

TABLE 4
Quantitative measurements of chocolate compositions
comprising maltodextrin and/or inulin

| | Recipe 4 | Recipe 5 |
|---|---|---|
| Fat (%) | 33.76 | 27.36 |
| Total Sugar (%) | 29.30 | 31.75 |
| Viscosity (Pa · s) | 1.1 | 6.44 |
| Yield value (Pa) | 8.54 | 37.3 |
| Particle size (μm) | 24 | 38 |
| L* | 34.57 | 34.07 |
| a* | 7.58 | 7.22 |
| b* | 6.9 | 4.37 |

### Example 3

A vegan chocolate was prepared containing inulin and maltodextrin using the ratios shown in Table 5. The vegan chocolate compositions according to the invention were made by following the same methodology as in example 1.

TABLE 5
Vegan chocolate composition comprising maltodextrin and inulin

| Recipe 6 | % |
|---|---|
| Sugar | 42.1 |
| Cocoa mass (Ghana) | 12.33 |
| Cocoa butter | 25.99 |
| Inulin (Fibruline Instant) | 9.46 |
| Maltodextrin (MD01915) | 9.46 |
| Soya lecithin | 0.60 |
| Standard natural vanilla flavour | 0.01 |
| Salt | 0.05 |
| TOTAL | 100 |
| Fat | 33.12 |
| Sugar | 43.56 |

The resulting chocolates had a desirable flavour and mouthfeel.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1. A confectionery composition comprising a bulking agent wherein the bulking agent comprises a partially hydrolysed starch and/or a dietary fibre, and wherein the confectionery composition is free or substantially free of high intensity sweeteners.

2. The confectionery composition according to claim 1, wherein the dietary fibre is selected from the group consisting of: inulin, oligofructose, resistant dextrin, bran, cocoa fibre, bamboo fibre, and mixtures of two or more thereof.

3. The confectionery composition according to claim 1, wherein the dietary fibre is inulin.

4. The confectionery composition according to claim 1, wherein the dextrose equivalence (DE) of the partially hydrolysed starch is from 10 to 40.

5. The confectionery composition according to claim 1, wherein the partially hydrolysed starch is maltodextrin or low DE glucose syrup.

6. The confectionery composition according to claim 1, wherein the partially hydrolysed starch is maltodextrin.

7. The confectionery composition according to claim 1, wherein the ratio of partially hydrolysed starch to dietary fibre in the bulking agent is 80:20, 70:30, 60:40, 50:50, 40:60, 30:70 or 20:80.

8. The confectionery composition according to claim 1, wherein the confectionery composition is a chocolate composition.

9. The confectionery composition according to claim 1 comprising from 10 to 25 wt % of the bulking agent relative to the total weight of the composition.

10. The confectionery composition according to claim 1 comprising from 4 wt % to 20 wt % of partially hydrolysed starch and/or from 4 wt % to 20 wt % of dietary fibre relative to the total weight of the composition.

11. The confectionery composition according to claim any of the claim 1, comprising:
45 wt % or less total sugars; and/or
substantially no milk solids.

12. A food product comprising the confectionery composition according to any one of the claim 1.
